(19) United States
(12) Patent Application Publication
(10) Pub. No.: US 2013/0186578 A1
(43) Pub. Date: Jul. 25, 2013

(54) SHADING ASSEMBLY

(71) Applicant: MACAUTO INDUSTRIAL CO., LTD., Tainan City (TW)

(72) Inventor: Paul Lin, Tainan City (TW)

(73) Assignee: MACAUTO INDUSTRIAL CO., LTD., Tainan City (TW)

(21) Appl. No.: 13/738,040

(22) Filed: Jan. 10, 2013

(30) Foreign Application Priority Data
Jan. 19, 2012 (TW) 101102203

(51) Int. Cl. E06B 9/42

(52) U.S. Cl. CPC E06B 9/42
USPC 160/271

(57) ABSTRACT

A shading assembly includes two parallel longitudinal guide rails that have respective longitudinal channels. A curtain has two lateral guided sides received in the channels. Two spiral spring strips are respectively inserted into the channels. Two connection strings respectively fasten the spiral spring strips to the guided sides. Each of the spiral spring strips has a plurality of spaced-apart connection holes. Each of the connection strings is sewn to a corresponding one of the spiral spring strips and a corresponding one of the guided sides and passes through the connection holes.

### CROSS-REFERENCE TO RELATED APPLICATION

This application claims priority to Taiwanese Application No. 101102203, filed on Jan. 19, 2012.

### BACKGROUND OF THE INVENTION

1. Field of the Invention

The invention relates to a shading assembly, and more particularly to a shading assembly having guide rails and spiral spring strips that are respectively fastened to the guide rails using connection strings.

2. Description of the Related Art

Referring to FIGS. 1 and 2, U.S. Pat. No. 7,114,766 B2 discloses a window blind 1 that is mounted beneath a sunroof of a vehicle (not shown). The window blind 1 includes two parallel guide rails 11, two mounting seats 12 that are respectively disposed rearward of the guide rails 11, and a sunshade unit 13 that includes a winding shaft 131 disposed rotatably between the counting seats 12, and a curtain 132 that is extendably wound around the winding shaft 131. Each of the guide rails 11 has a bottom wall, a top wall parallel with the bottom wall, and a side wall that connects the bottom and top walls. The bottom wall, the top wall and the side wall of each guide rail 11 define a channel 111 that extends in a front-rear direction. Each guide rail 11 further includes a hook wall 112 that extends from the bottom wall, that is bent toward the channel 111 and that is more proximate to the other one of the guide rails 11 compared to the side wall. The curtain 132 has two opposite guided sides 133 that are respectively and movably received in the channels 111.

In use, the curtain 132 can be extended or retracted along the two guide rails 11, so that the guided sides 133 of the curtain 132 can respectively and longitudinally move along a lengthwise direction of the channels 111. For smoothness of take-up and extension of the curtain 132, the window blind 1 further includes a retainer unit 14 that includes two spiral spring strips 141 that are respectively adhered to the guided sides 133 of the curtain 132 by two adhesives 142. Each spiral spring strip 141 has an adhered portion 143 that longitudinally extends and that is attached to the corresponding guided side 133 by the corresponding adhesive 142, and a non-adhered portion 144 that longitudinally extends and that is spaced apart from the corresponding guided side 133. Each of the hook walls 112 extends to a space between the corresponding non-adhered portion 144 and the corresponding guided side 133, so that each of the spiral spring strips 141 may be elastically and abuttingly received in the channel 111 of the corresponding guide rail 11, thereby preventing the corresponding guided side 133 of the curtain 132 from disengaging the channel 111.

Since attachment of the spiral spring strips 141 to the guided sides 133 is through the adhesives 142, the spiral spring strips 141 and the guided, sides 133 have to be carefully aligned with each other and surfaces of the adhered portions 143 have to be kept clean prior to adhering so as to ensure the effective attachment of the spiral spring strips 141 to the guided sides 133. Hence, such attachment requires much time and work, and defects such as wrinkling easily occur among the adhered portions 143 and the guided sides 133. It requires a relatively high production cost to accomplish such attachment among the guided sides 133, the adhesives 142 and the adhered portions 143 and manufacturing rate tends to be relatively low. Furthermore, the adhesives 142 may deteriorate after pulling of the curtain 132. As a consequence, the spiral spring strips 142 tend to be shifted and peeled off and lose their support function, so that the curtain 132 may not be smoothly extended and retracted.

### SUMMARY OF THE INVENTION

Therefore, an object of the present invention is to provide a shading assembly that can alleviate at least one of the aforesaid drawbacks of the prior art.

According to the present invention, a shading assembly includes two parallel longitudinal guide rails, a mounting unit, a sunshade unit, and a retainer unit.

The two parallel longitudinal guide rails have respective longitudinal channels that extend in a front-rear direction.

The mounting unit is disposed rearward of the guide rails.

The sunshade unit is mounted on the mounting unit and has a curtain. The curtain has two lateral guided sides that are movably and respectively received in the channels.

The retainer unit includes two spiral spring strips that are respectively inserted into the channels, and two connection strings that respectively fasten the spiral spring strips to the guided sides. Each of the spiral spring strips has a plurality of spaced-apart connection holes. Each of the connection strings is sewn to a corresponding one of the spiral spring strips and a corresponding one of the guided sides, and passes through the connection holes of the corresponding one of the spiral spring strips. The spiral spring strips are movable relative to the channels between a forwardly stretched and extended position and a rearward retracted rolled-up position.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of the a conventional window blind disclosed in U.S. Pat. No. 7,114,766 B2;

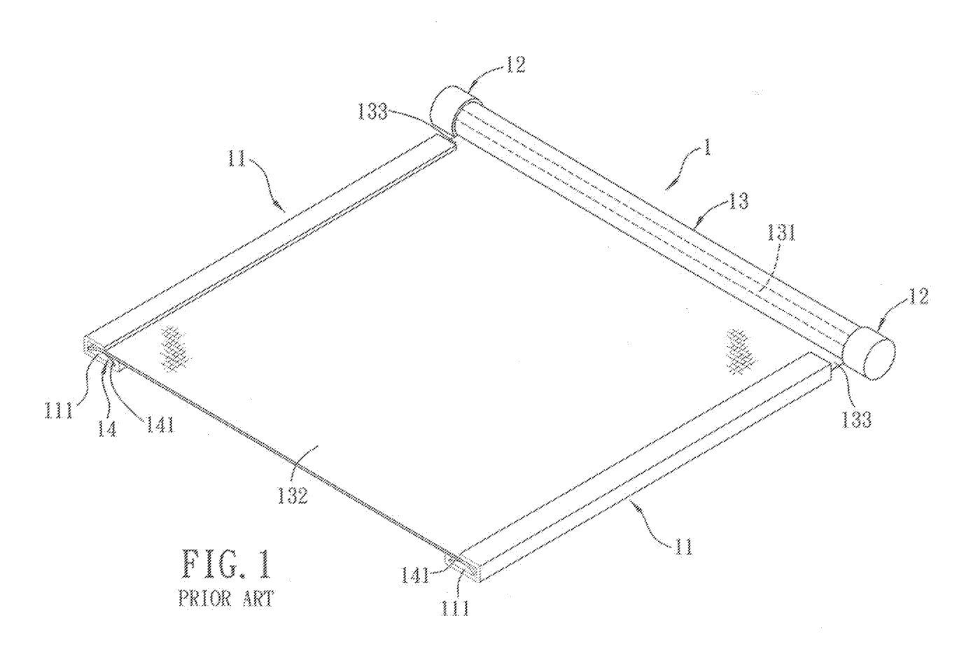

FIG. 2 is a fragmentary sectional view of the conventional window blind;

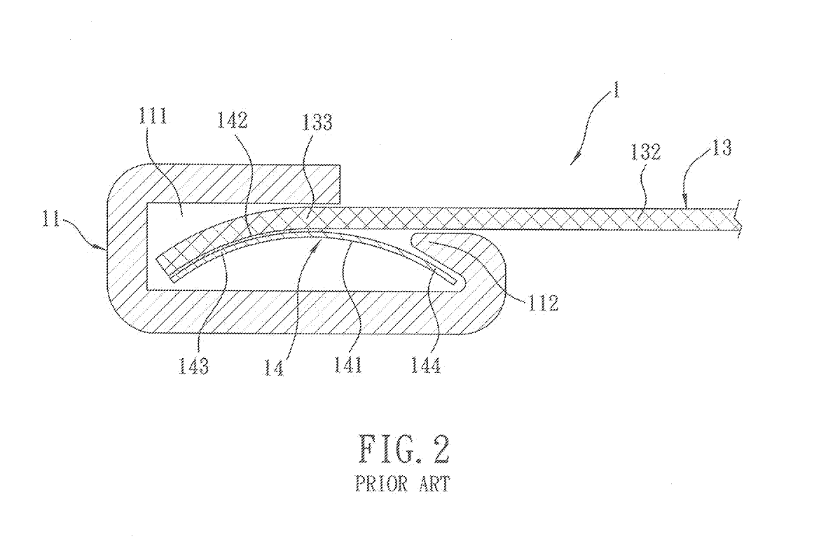

FIG. 3 is a perspective view, illustrating a first preferred embodiment of a shading assembly according to the present invention;

FIG. 4 is a fragmentary side sectional view of the first preferred embodiment;

FIG. 5 is a fragmentary front sectional view of the first preferred embodiment; and

FIG. 6 is a fragmentary sectional view of a second preferred embodiment of the present invention.

### DETAILED DESCRIPTION OF THE PREFERRED EMBODIMENTS

Before the present invention is described in greater detail, it should be noted that the same reference numerals nave been used to denote like elements throughout the specification.

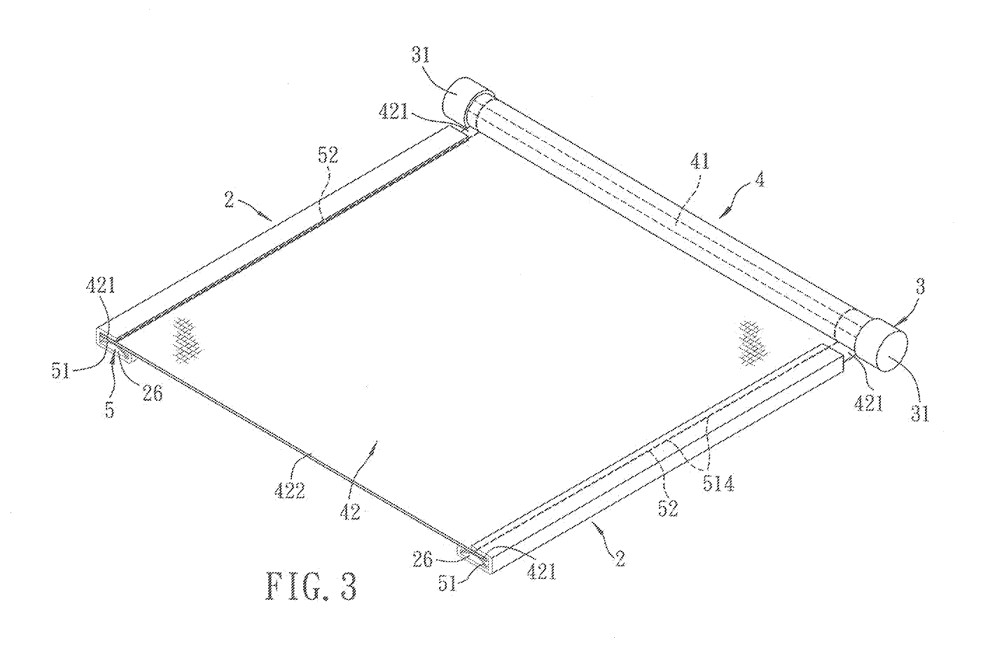

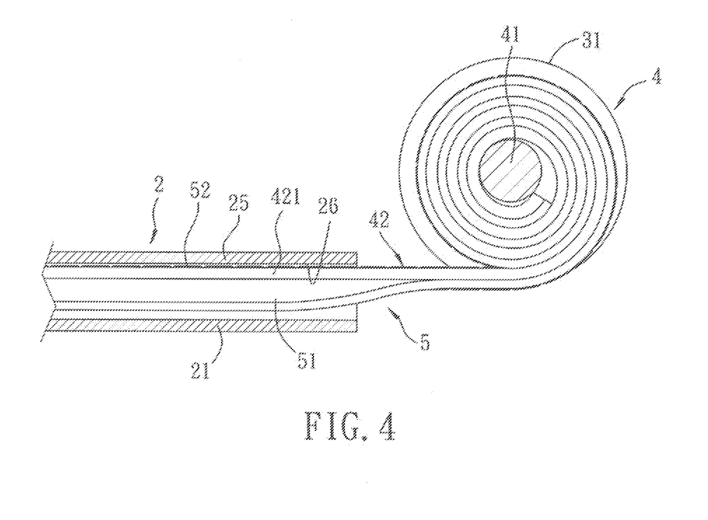

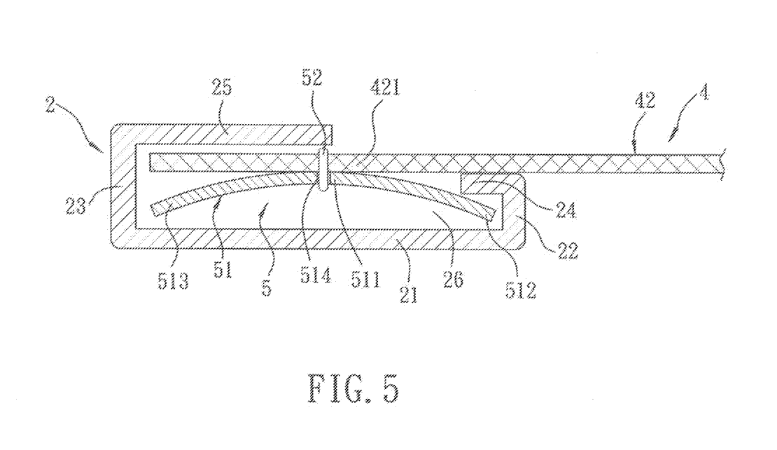

FIGS. 3 to 5 illustrate the first preferred embodiment of a shading assembly according to the present invention. The shading assembly is adapted to be installed beneath a ceiling in proximity to a sunroof of a vehicle (not shown). In this embodiment, the shading assembly includes two parallel longitudinal guide rails 2, a mounting unit 3, a sunshade unit 4, and a retainer unit 5.

The two parallel longitudinal guide rails 2 are adapted to be respectively disposed beneath two opposite sides of the sunroof and to bb fixed on the ceiling of the vehicle. The two parallel longitudinal guide rails 2 have respective longitudinal channels 26 that extend in a front-rear direction. Preferably, each of the guide rails 2 has a longitudinal bottom wall 21 that extends in the front-rear direction, an inner wall 22 that extends upwardly from one side of the bottom wall 21 proximate to the other one of the guide rails 2, an outer wall 23 that extends from another side of the bottom wall 21 distal from the other one of the guide rails 2 and that is opposite to and parallel with the inner wall 22, an inner top wall 24 that extends from a top end of the inner wall 22 toward the cuter wall 23, and an outer top wall 25 that extends from a top end of the outer wall 23 toward the inner wall 22. A distance between the outer top wall 25 and the bottom wall 21 is greater than a distance between the inner top wall 24 and the bottom wall 21, such that the outer top wall 25 and the inner top wall 24 are spaced apart from each other in a direction transverse to the bottom wall 21. The bottom wall 21, the inner wall 22, the outer wall 23, the inner top wall 24, and the outer top wall 25 of one of the longitudinal guide rails 2 cooperatively define a corresponding one of the channels 26 that opens toward the channel 26 of the other one of the longitudinal guide rails 2.

The mounting unit 3 is disposed rearward of the guide rails 2, and has two mounting seats 31 that are spaced apart from each other and that are respectively installed rearwardly of the guide rails 2. Alternatively, in actual implementation, the mounting seats 31 may be formed as one piece. However, since the feature of she shading assembly of this invention does not reside in the configuration of the mounting seats 31, which may be readily appreciated by those skilled in the art, details of the same are omitted herein for the sake of brevity.

The sunshade unit 4 is mounted on the mounting unit 3 and has a curtain 42. The curtain 42 has two lateral guided sides 421 that are movably and respectively received in the channels 26. Preferably, the sunshade unit 4 further has a winding shaft 41 that is rotatably disposed on the mounting unit 3 so as to be installed between the two mounting seats 31. The curtain 42 is expendably wound around the winding shaft 41. In this embodiment, the curtain 42 has a free end 422 that interconnects the two guided sides 421 and that is movable relative to the winding shaft 41. In some embodiments, the sunshade curtain 42 may further have a pull rod (not shown) that is connected to the free end 422 in a direction transverse to the guide rails 2 and that is distal from the winding shaft 41. The pull rod may be movable between the guide rails 2 and may move along the channels 26. In actual implementation, the sunshade unit 4 may be a motor-driven, manual, or semi-automatic mechanism. In some embodiments, the sunshade unit 4 may also be designed with a pull and stop mechanism. In addition, the curtain 42 may be designed to be hooked and positioned at a completely extended position, and to be retractable without requiring a manually applied force. Since the feature of this invention does not reside in how the curtain 42 is driven to be extended or retracted, which may be readily appreciated by those skilled in the art, details of the same are omitted herein for the sake of brevity.

The retainer unit 5 includes two spiral spring strips 51 that are respectively inserted into the channels 26, and two connection strings 52 that respectively fasten the spiral spring strips 51 to the guided sides 421 of the curtain 42. Therefore, the two spiral spring strips 51 are associated with the curtain 42 to be extendably wound around the winding shaft 41. In this embodiment, each of the spiral spring strips 51 has a plurality of spaced-apart connection holes 514. Each of the connection strings 52 is sewn to a corresponding one of the spiral spring strips 51 and a corresponding one of the guided sides 421, and passes through the connection holes 514 of the corresponding one of the spiral spring strips 51. The spiral spring strips 51 are movable relative to the channels 26 between a forwardly stretched and extended position and a rearward retracted rolled-up position.

Preferably, each of the spiral spring strips 51 in a corresponding one of the guide rails 2 has a longitudinal central spine portion 511 and inner and outer side positions 512, 513 that respectively extend on two opposite sides of the central spine portion 511. The inner side position 512 is oriented toward the other one of the guide rails 2. The outer side position 513 is oriented away from the other one of the guide rails 2. The connection holes 514 in each of the spiral spring strips 51 are spaced apart in the central spine portion 511. Each of the connection strings 52 is sewn to the central spine portion 511 and the corresponding one of the guided sides 421. In this embodiment, each connection string 52 is a string made of a stainless steel (SUS304). However, the material and the strand count of the connection strings 52 may be modified according to the required bonding strength between the spiral spring strips 51 and the curtain 42.

In this preferred embodiment, each of the spiral spring strips 51 is elastically coiled around the winding shaft 41 and has a cross-sectional shape with a width greater than the width of the corresponding one of the channels 26. Each spiral spring strip 51 is stretched with the corresponding one of the guided sides 421 and inserted into the corresponding one of the channels 26 in the front-rear direction. Hence, each of the spiral spring strips 51 is retained so as to be bent and so as to have a substantially arcuate cross-sectional shape. The outer side position 513 and the inner side position 512 of each spiral spring strip 51 are restorable to bend away from the curtain 42. The central spine portion 511 is in contact with the curtain 42. By virtue of engagement among the spiral spring strips 51, the guided sides 421 and the channels 26, the curtain 42 may smoothly and flatly extend between the two guide rails 2.

Specifically, each of the spiral spring strips 51 presents a spiral from when an applied force does not act thereon. When each spiral spring strip 51 is pulled to stretch along the front-rear direction, each spiral spring strip 51 may have a restoring force, thereby enabling the curtain 42 to be restored and wound around the winding shaft 41 by the restoring force of the spiral spring strips 51. Preferably, the sunshade unit 4 may further include at least one resilient member (not shown) having two opposite ends. One of the opposite ends of the resilient member is fixed and the other of the opposite ends is connected to the winding shaft 41 so that the resilient member provides a resilient force to drive rotation of the winding shaft 41 to have a tendency towards a take-up state, i.e., the sunshade curtain 42 tends to be wound around the winding shaft 41 without an external force. Since the feature of this invention does not reside in the configuration of the resilient member, which may be readily appreciated by those skilled in the art, details of the same are omitted herein for the sake of brevity. In actual implementation, the winding shaft 41 may be omitted from the sunshade unit 4 because the certain 42 may be taken up through the restoring force of the spiral spring strips 51.

In use, the free end 422 of the curtain 42 is driven to move relative to the mounting unit 3, such that the curtain 42 is extended a distance from the winding shaft 41 along the front direction. The guided sides 421 and the spiral spring stripe 51 are together movable relative to the guide rails 2. The spiral spring strips 51 are extended from the winding shaft 41, and are forwardly and stretchably inserted into the channels 26, respectively. Each spiral spring strip 51 is at the forwardly stretched and attended position in the corresponding one of the channels 26. The central spine portion 511 is in contact with the corresponding one of the guided sides 421. The outer and inner side positions 513, 512 bend away from the corresponding guided side 421. Therefore, the inner top wall 24 of the corresponding guide rail 2 extends between the inner side position 512 of the spiral spring strip 51 and the corresponding guided side 421 of the curtain 42. The outer top wall 25 is proximate to the corresponding guided side 421 of the curtain 42 and distal from the spiral spring strip 51. Accordingly, the curtain 42 may be prevented from being taken off the guide rails 2.

When the free end 422 of the curtain 42 is pushed rearward to move relative to the mounting unit 3 and to move toward the winding shaft 41, the curtain 42 is retracted toward and around the winding shaft 41. The guided sides 421 and the spiral spring strips 51 are together rearwardly movable relative to the guide rails 2. The spiral spring strips 51 depart from the channels 26 and are retracted around the winding shaft 41 at a take-up position of a spiral shape. At the take-up position, the guided side 421 is in contact with the central spine portion 511, the outer side position 513, and the inner side position 512 so as to facilitate retraction of the curtain 42 and the spiral spring strips 51.

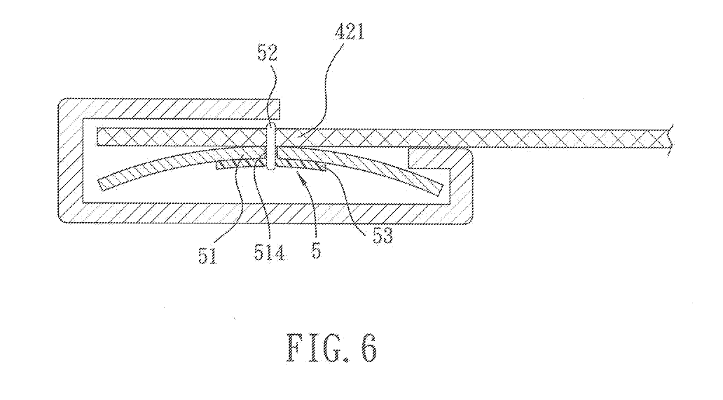

FIG. 6 shows the second preferred embodiment of a shading assembly according to this invention, which has a structure generally similar to that of the first preferred embodiment. In this embodiment, the retainer unit 5 further includes two reinforcing pads 53, each of which is stacked beneath the central spine portion 511 of one of the spiral spring strips 51 and disposed oppositely of the curtain 42. Each of the connection strings 52 is sewn to the curtain 42, one of the spiral spring strips 51 and one of the reinforcing pads 53. By virtue of sewing using the connection strings 52, the reinforcing pads 53 extend into the connection holes 514. Due to the reinforcing pads 53, the connection strings 52 may not only be firmly sewn to the curtain 42 and the spiral spring strips 51, but may also be prevented from being cut by rubbing with the spiral spring strips 51. The number of the reinforcing pads 53 may vary according to requirements, and the present invention is not limited in this respect.

To sum up, in the retainer unit 5 of the present invention, the connection holes 514 in each spiral spring strip 51 are spaced apart and formed in a line in the central spine portion 511. Each connection string 52 may pass through the connection holes 514 so as to sew together the corresponding spiral spring strip 51 and the corresponding guided side 421 of the curtain 42. The bonding between the retainer unit 5 and the curtain 4 conducted by sewing is more convenient than using the adhesive, the fabrication time and cost can be saved, and the manufacturing rate with good quality can be increased. Due to the firm connection between the guided sides 421 and the spiral spring strips 51, the guided sides 421 may be prevented from being loosened or taken off the channels 26, such that the curtain 42 may avoid being obliquely movable along the guide rails 2.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A shading assembly, comprising:
two parallel longitudinal guide rails having respective longitudinal channels extending in a front-rear direction;
a mounting unit disposed rearward of said guide rails;
a sunshade unit mounted on said mounting unit and having a curtain, said curtain having two lateral guided sides that are movably and respectively received in said channels; and
a retainer unit including two spiral spring strips that are respectively inserted into said channels, and two connection strings that respectively fasten said spiral spring strips to said guided sides of said curtain, each of said spiral spring strips having a plurality of spaced-apart connection holes, each of said connection strings being sewn to a corresponding one of said spiral spring strips and a corresponding one or said guided sides and passing through said connection holes of the corresponding one of said spiral spring strips, said spiral spring strips being movable relative to said channels between a forwardly stretched and extended position and a rearward retracted rolled-up position.

2. The shading assembly as claimed in claim 1, wherein each of said spiral spring strips in a corresponding one of said guide rails has a longitudinal central spine portion and inner and outer side positions that respectively extend on two opposite sides of said central spine portion, said inner side position being oriented toward the other one of said guide rails, said outer side position being oriented away from the other one of said guide rails, said connection holes in each of said spiral spring strips being spaced apart in said central spine portion, each of said connection strings being sewn to said central spine portion.

3. The shading assembly as claimed in claim 2, wherein each of said spiral spring strips has a substantially arcuate cross-sectional shape, said outer side position and said inner side position bending away from said curtain, said central spine portion being in contact with said curtain.

4. The shading assembly as claimed in claim 3, wherein each of said guide rails has a longitudinal bottom wall, an inner wall that extends upwardly from one side of said bottom wall proximate to the other one of said guide rails, an outer wall that extends from another side of said bottom wall distal from the other one of said guide rails and that is opposite to and parallel with said inner wall, an inner top wall that extends from a top end of said inner wall toward said outer wall, and an outer top wall that extends from a top end of said outer wall toward said inner wall, said bottom wall, said inner wall, said outer wall, said inner top wall, and said outer top wall cooperatively defining a corresponding one of said channels, said inner top wall extending between said inner side position of said spiral spring strip and said curtain, said outer top wall being proximate to said curtain and distal from said spiral spring strip.

5. The shading assembly as claimed in claim 2, wherein said retainer unit further includes two reinforcing pads each of which is stacked beneath said central spine portion of one of said spiral spring strips and disposed oppositely of said curtain, each of said connection strings being sewn to said curtain, one of said spiral spring strips and one of said reinforcing pads.

6. The shading assembly as claimed in claim 1, wherein said sunshade unit further includes a winding shaft that is disposed on said mounting unit, said curtain being extendably wound around said winding shaft.
